(19) United States
(12) Patent Application Publication
(10) Pub. No.: US 2017/0348175 A1
(43) Pub. Date: Dec. 7, 2017

(54) Spine alignment and massage device

(71) Applicant: GREGG JOHN EMMEL, VENICE, CA (US)

(72) Inventor: GREGG JOHN EMMEL, VENICE, CA (US)

(21) Appl. No.: 14/999,624

(22) Filed: Jun. 7, 2016

(51) Int. Cl. A61H 1/02; A61H 7/00

(52) U.S. Cl. CPC A61H 1/0292; A61H 7/001; A61H 2205/081; A61H 2201/0157

(57) ABSTRACT

A spine alignment and massage device with a rigid member have an elliptically shaped top plan view and a left and a right protrusion. The raised protrusions are mirror images of each other. The inside surface of each the protrusion is approximately eighty-four degrees in angle forming a V shaped space between the two protrusions. The outside surface of each protrusion slops down at approximately forty-five degrees. The distance between the top of the two protrusions are approximately one and three quarters of an inch. The height of each protrusion is approximately two inches. The top portion of each the protrusion is a hemisphere of approximately one half of one inch in diameter. The base portion of the rigid member is curved along the short axis and has a radius of approximately twelve inches. In an alternate embodiment, the device is made of semi-rigid material.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable massage devices and more specifically to spine alignment and massage device.

This invention relates generally to the field of portable massage devices and more specifically passive resistance muscular-skeletal manipulation devices. In recent years, the problem of back pain has become chronic in the United States. A recent Newsweek Magazine report has stated that over sixty-five million Americans share this painful affliction. The article goes on to state that back pain has become the number two reason for adult visits to a doctor; second only to coughs and colds. Although some types of back pain are so severe that only surgery may be an option, it has also been shown that various types of back massage combined with muscle strengthening exercises can be very effective in easing or eliminating back pain. To this end, a number of portable massage devices have been invented and marketed so that a person can perform a back massage on his or herself for example, Christian. Howard, in his 2001 U.S. Pat. No. 6,315,742 discloses a device in which a plurality of ball shapes are mounted to a board so that the user can place the balls under his or her back and roll forward and backward on the balls to massage the spine and back. Similarly, Amos Stauft, in his 1983 U.S. Pat. No. 4,374,519, discloses a spinal massage device comprising four rubber balls mounted to a linking plate. This device is used in a similar way to the Howard device. The user's back is meant to lie on the balls and move forward and backward to allow the balls to travel up and down the user's spinal cord area. While these devices do aid in the ease of muscle tension in the back area, they have a number of deficiencies which the present invention remedies. The main deficiency is that the prior devices are generally simple ball or other radial shapes and do not incorporate profiles of specific size and shape to allow the device to both massage the area on either side of the spine and to help align the vertebrae of the spine at the same time. Additionally, my experiments have shown that it is efficacious for a person to have the choice to physically lie on or slide on a stationary contoured shape as well as the ability to cause the contoured shape to move up the user's spine by the user performing a rocking action as will be described in detail in the description below.

### BRIEF SUMMARY OF THE INVENTION

The primary object of the invention is to provide a spine alignment and massage device that is portable and can be used by a person to align the vertebrae of the spine and to massage the musculature on either side of the spine.

Another object of the invention is to provide a spine alignment and massage device that include a radiused base to allow the device to be rocked by the user during use thereby allowing the user to more easily slide his or her spine over the device.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a spine alignment and massage device comprising: a rigid member have an elliptical top plan view and a left and a right protrusion, said raised protrusions being mirror images of each other, the inside surface of each said protrusion being approximately eighty-four degrees in angle forming a V shaped space between said two protrusions, the outside surface of each said protrusion sloping down at approximately forty-five degrees, the distance between the top of said two protrusion being approximately one and three quarters of an inch, the height of each protrusion being approximately two inches, the top portion of each said protrusion being a hemisphere of approximately one half of one inch in diameter, and the base portion of said rigid member being curved and having a radius of approximately twelve inches.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a top plan view of the invention.

FIG. 3 is a front section view of the invention.

FIG. 4 is a perspective view of a person about to use the invention.

FIG. 5 is a perspective view of a person in the middle of the use of the invention.

FIG. 6 is a perspective view of a person at the three quarters stage of the use of the invention.

FIG. 7 is a perspective view of a person at the end of the use of the invention.

FIG. 8 is a perspective view of the rear view of a person using the invention.

FIG. 9 is a section view of the invention in the start position.

FIG. 10 is a section view of the invention in the rocked use position.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

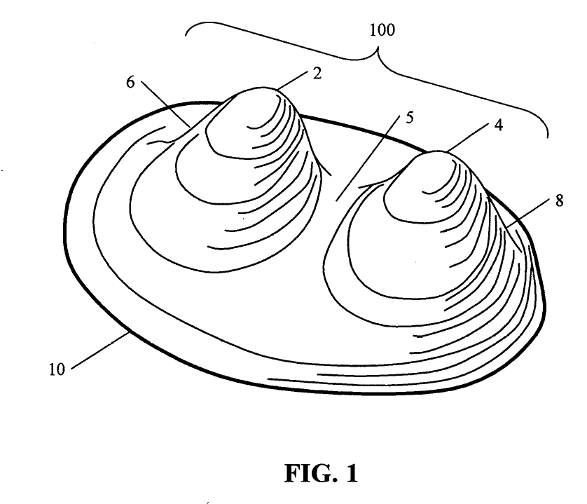

Referring now to FIG. 1 we see a perspective view of the spine alignment and massage device 100. The base 10 of the device is elliptical. There is a left and a right raised protuberance each terminating in a hemisphirically shaped top 2, 4 approximately one half of one inch radius. The raised portions are mirror images of each other. The space 5 between protuberances 6, 8 is V shaped and is formed by the relatively flat inner facing side walls of each raised portion 6,8.

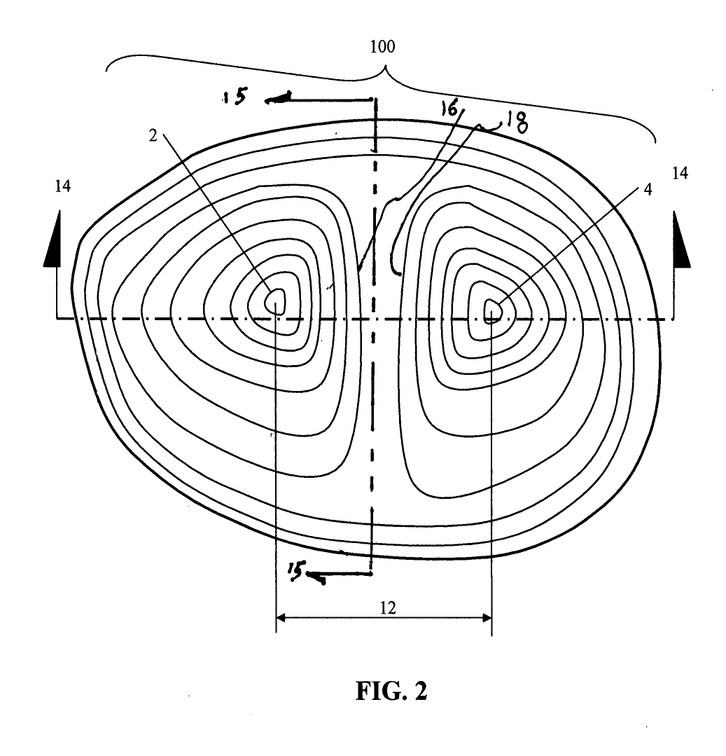

FIG. 2 is a top plan view of the invention 100. The distance between the top 2,4 of each raised approximately one and one quarter of an inch. The height of each raised portion 6,8 is approximately two inches. Each raised portion includes relatively flat inner wall as shown by topological lines 16, 18. The V shape created by the two raised portions 6, 8 is the perfect size to cradle the vertebrae of the human spine. The angle of each inside wall is approximately eighty-four degrees. The angle of the far walls taper that down to the left and right ends of the device at approximately forty-five degrees.

When a person lies in the prone position with the face up and the device 100 situated under his or her spine, the top portions 2, 4 of the device straddle the vertebrae of the spine and can help bring the vertebrae back into alignment as the user slides his or her body over the device 100. Additionally the tops of the raised portions 2, 4 can massage the musculature on either side of the spine to help release pain and or tension that may be stored there.

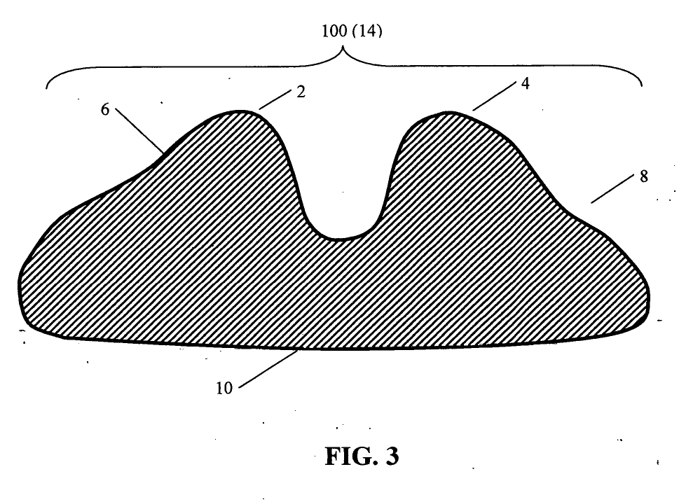

FIG. 3 is a front section view of the invention 100 as defined by section line 14 shown in FIG. 2. This view clearly shows the V shaped formed between the raised portions 6, 8 and also a relatively flat shape 10 to the bottom of the device.

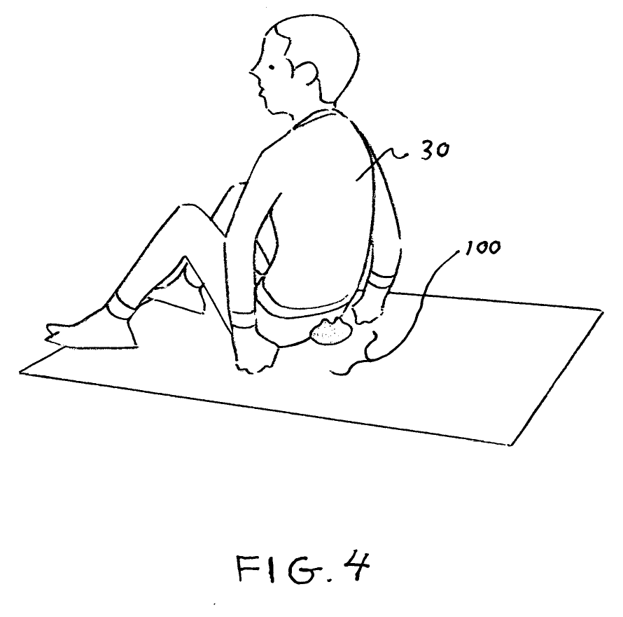

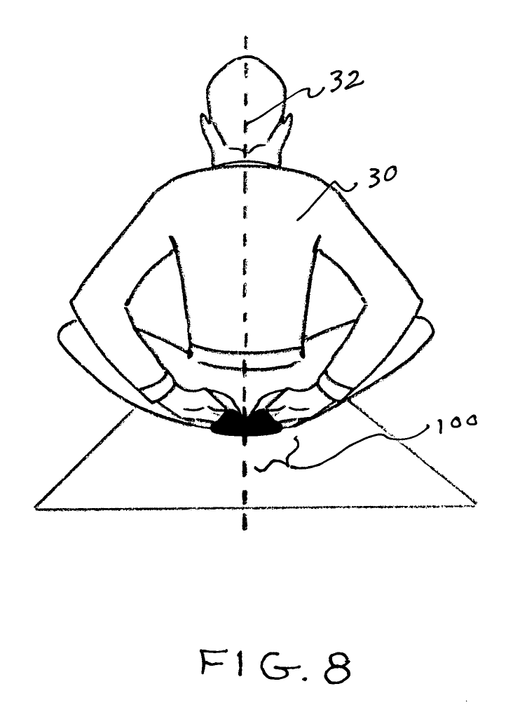

FIG. 4 is a perspective view of a person 30 about to use the invention 100. The person is in a sitting position with the invention 100 at the base of his spine. The user 30 aligns the invention 100 so that each rounded protrusion 2, 4 straddles the spine as shown in more detail in FIG. 8 where the invention in the start position and is perpendicular 32 with the person's 30 spine.

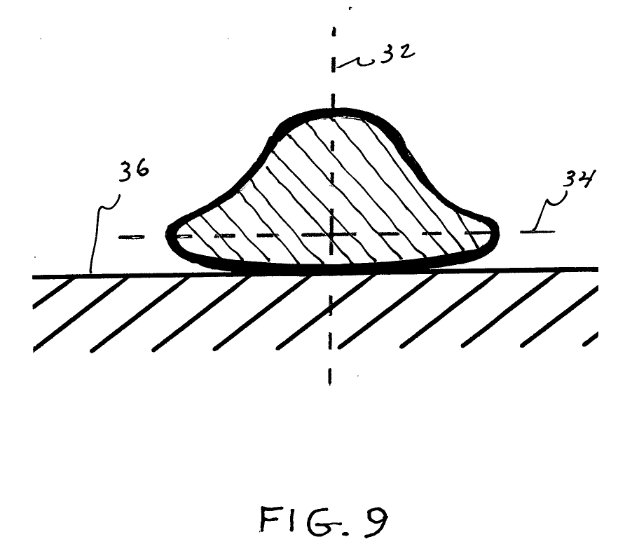

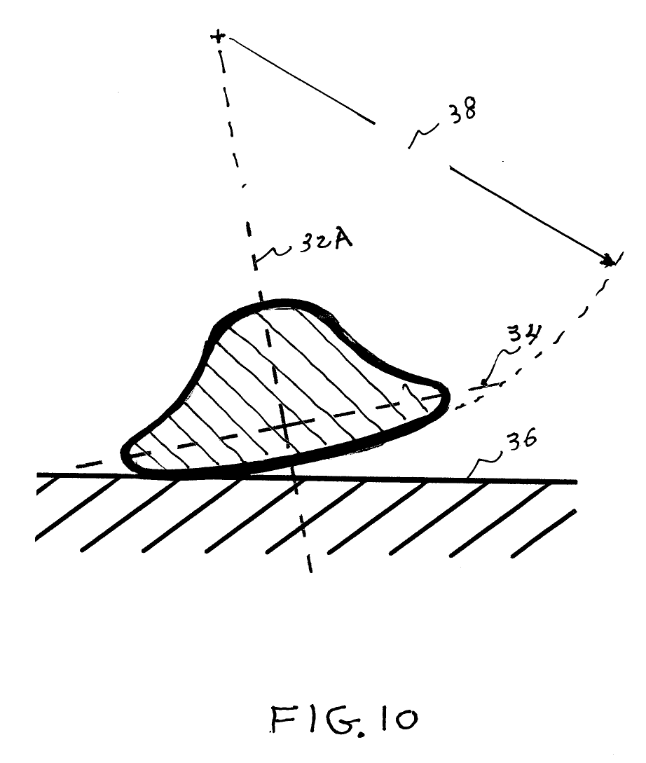

The invention 100 has a curved surface as shown in the section views in FIGS. 9 and 10 as defined by section line 15 shown in FIG. 2. The radius 34 of the curved bottom is approximately twelve inches 38 as shown in FIG. 10. A rocking action as shown by the difference between the horizontal plane 32 in FIG. 9 and the rocked plane 32A in FIG. 10 as it sits on horizontal surface 36.

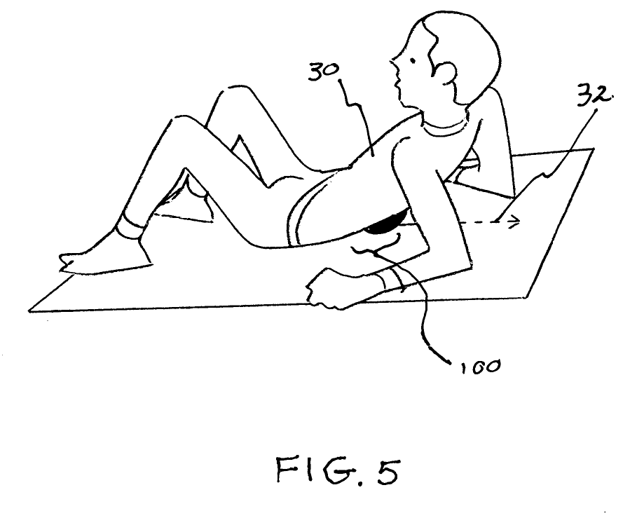

FIG. 5 is a perspective view of the person 30 in the process of using the invention 100 where, by use of support of elbows and buttocks, the user can rock the invention and cause it to slip forward 32, like a bar of soap, in a linear motion toward the top of the spine.

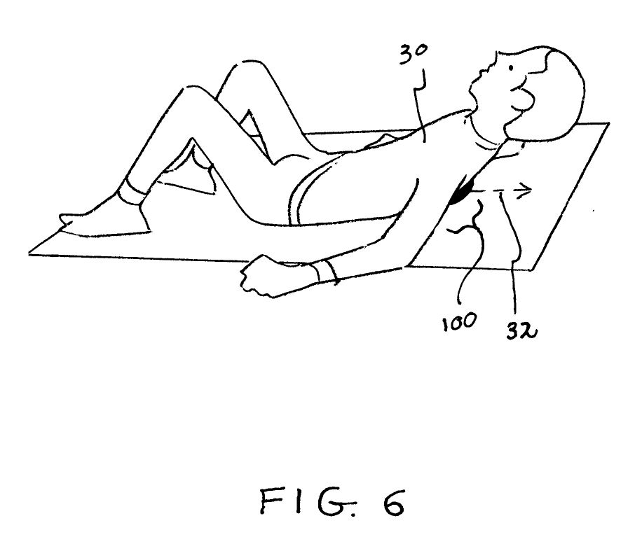

FIG. 6 is a perspective view of the person 30 with the invention 100 about three quarters of the way up the user's spine and continuing to be moved up the spine as shown by dotted line 32.

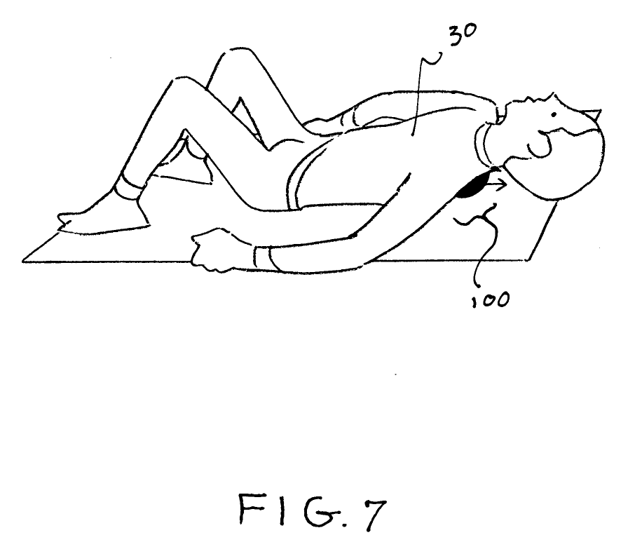

FIG. 7 is a perspective view of the person 30 with the invention 100 located almost to the neck region. The user can complete the alignment and massage experience at the neck region, and then start again from the base of the spine if so desired.

Below is a description of how to use the massage device 100 referred to as the Align tool.

The Align tool should lie placed on a reasonably hard surface such as a rug on a hardwood floor, and the user should be wearing a comfortable t-shirt or clothing to help in the movement of the Align tool if they do not want to use oils.

Breathing is extremely important to help move the users knots out of the way and centering one's mind. Drinking water before and after working out is also important to flush away toxins released from physical practices.

The Align tool has a curved bottom in one direction, which gives this particular tool the ability to rock, and also move perpendicular to that rocking direction, which also gives the Align tool a tendency to travel along that path in multiple configurations using the users body, floor or surface and the Align tool as a fulcrum which propels the Align tool along the Spinal column.

The Align tool's two protruded bumps act as the fulcrum point for the user's body and are shaped so the angle of attack or force of the user's body at the point of contact comes from off-center and at varying angles to that fulcrum point and in conjunction with the curved bottom, the Align tool can be made to move.

As in “configurations”, I mean the different ways the Align tool either moves and/or stays in place, while in direct correlation to the user's body moving and/or staying in place, and also the Align tool and the users body moving together over the floor or surface. This back and forth ability of the Align tool to not move while the body floats over it, then being able to move by its self, then with the Align tool and body moving as one over the floor or surface is achieved simply by the angle of attack, pressure from the user's body, shape of the Align tool and the curved bottom of the Align tool.

It's the entire ergonomic shape and use of the Align tool: the protrusions, the curved bottom and the force from the user's body together make the Align tool travel from the buttocks to the skull. These design factors and abilities of the Align tool are the major reasons the Align tool can realign and clear the spinal column of knots, and blocked energy.

While facing up and laying on their back, the users place the Align tool at the base of the back by aching the back and using the glutes (buttocks), heels, elbows, shoulders and or head to raise the body. Using their hands to position the Align tool, the user can feel the Align tool nestle the vertebra from both sides of the spine. Gently lowering down for a moment using their body, elbows and heels to adjust the pressure on the contact point according to the user's condition and pain threshold.

When the user is ready to clear the spine, starting at the lower back, nestling the vertebra onto the Align tool breathing into the feeling. Sense what is happening with the Align tool, and where the Align tool is located around the vertebra. It is a process of adjustment and repositioning if necessary. Focus on breathing and visualizing the vertebra getting cleared away and releasing tension. The user can hold the back of the neck with interlocking fingers to help support the head while pushing and sliding over the Align tool.

Inhaling and exhaling with downward pressure along the spine using the Align tool as a fulcrum point which causes the Align tool to slide and move short distances. Adjusting ones position with heels and elbows pushing the Align tool along from the lower spine to the middle spine with the body moving over the Align tool and then the Align tool moving along the spine while the body stays still, then reposition using ones heels and body to push the Align tool and body together along the middle spine. Taking a moment to feel the Align tool and the body, the user can feel blocked energy released. Positioning with the Align tool once again staying in place with the body moving over the Align tool, then with a slight change in the angle of attack to the fulcrum point the body stays in place as the Align tool is propelled, up past the shoulder blades and to the upper spine by itself as the body stays in place and the Align tool moves though ones' upper vertebra. The user can take the Align tool in their hands completing the final upper vertebra to the base of their scull holding the Align tool and breathing, releasing tension. Resting a moment to relax, feel, breath and let the pain go.

In a final move that elongates the spine and aligns the vertebra, the user can hold the back of the neck with interlocking fingers and gently stretch into their body pointing toes up and out and head toward the chest. The user may literally hear misaligned vertebrae realign themselves during this vertebra stretching exercise while feeling tension leave the body.

The user can also simply lie on the Align tool in different places adjusting manually by lifting up the body and adjusting the Align tool with their hands and gently lowering on the Align tool to feel the body. When a sore spot is encountered, ease the pressure, and gently work into the spot with the Align tool for several moments with a focus on breathing.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. spine alignment and massage device comprising:
a rigid member having an elliptically shaped top plan view and a left and a right protrusion;
said raised protrusions being mirror images of each other;
the inside surface of each said protrusion being approximately eighty-four degrees in angle forming a V shaped space between said two protrusions;
the outside surface of each said protrusion sloping down at approximately forty-five degrees;
the distance between the top of said two protrusions being approximately one and three quarters of an inch;
the height of each protrusion being approximately two inches;
the top portion of each said protrusion being a hemisphere of approximately one half of one inch in diameter; and
the base portion of said rigid member being curved along the short axis and having a radius of approximately twelve inches.

2. A spine alignment and massage device as claimed in claim 1 wherein and alternate embodiment, the said device is made of semi-rigid material.

3. A spine alignment and massage device as claimed in claim 1 wherein when a user lies in a prone, face up position and places his or her spine in the said V shape of said device, said device can help align the user's vertebrae and can massage the musculature on either side of the vertebrae.

4. A spine alignment and massage device as claimed in claim 1 wherein the curved nature of said base allows the user to rock the device as he or she arches the spine thereby causing the spine to be able to slide along the said device and to align and massage the entire length of the spine.
